(19) United States
(12) Patent Application Publication
(10) Pub. No.: US 2005/0185228 A1
(43) Pub. Date: Aug. 25, 2005

(54) Digital multifunctional apparatus having rotational scanning unit

(75) Inventor: In-Sik Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/022,631

(22) Filed: Dec. 28, 2004

(30) Foreign Application Priority Data
Feb. 20, 2004 (KR) 2004-11325

(51) Int. Cl. H04N 1/21

(52) U.S. Cl. 358/486; 358/493

(57) ABSTRACT

Disclosed is a digital multifunctional apparatus having a rotational scanning unit. The apparatus comprises a scanning unit scanning a document to convert an optical signal to an electric signal; a printing unit positioned under the scanning unit and printing a paper; a paper discharge unit occupying a predetermined space between the scanning unit and the printing unit; a scanning unit coupling member extending downward from one terminal portion of the scanning unit and being partially bent toward the scanning unit to be nearly parallel to the bottom surface of the scanning unit; a scanning unit connecting groove formed in a portion of a top surface of the printing unit corresponding to the scanning unit coupling member and rotatably accommodating the scanning unit coupling member; and a connecting groove cover limiting rotation of the scanning unit within a predetermined range of angle and partially covering the scanning unit connecting groove.

### CROSS-REFERENCE TO RELATED APPLICATION

This application claims the benefit under 35 U.S.C. §119(a) of Korean Patent Application No. 2004-11325, filed on Feb. 20, 2004, in the Korean Intellectual Property Office, the entire disclosure of which is hereby incorporated by reference.

### BACKGROUND OF THE INVENTION

1. Field of the Invention

The present invention relates to a digital multifunctional apparatus. More particularly, the present invention relates to a digital multifunctional apparatus having a rotating scanning unit.

2. Description of the Related Art

FIG. 1 illustrates a conventional small-sized digital multifunctional apparatus which combines several office automation (OA) apparatuses, such as a scanner, a facsimile, and a printer.

Referring to FIG. 1, the digital multifunctional apparatus is divided into a scanning unit 10, a printing unit 20, and a paper storage cassette 30. The scanning unit 10 includes a platen glass 13, a platen cover 11, and an image sensor 15. The platen glass 13 serves to mount a document 17 on an upper portion of the apparatus, and the platen cover 11 is used to cover a document 17 or the platen glass 13. The image sensor 15 converts an optical signal, which is obtained by scanning a document 17, into an electrical signal. Within the printing unit 20 disposed under the scanning unit 10, a paper discharge unit 21 is installed to store papers, which have been printed and discharged, and occupies a predetermined space. The printing unit 20 includes an image forming unit, a transfer roller 26, a fuser unit 27, and at least one or more paper discharge rollers 28. The image forming unit includes a developing unit 23 and a photosensitive drum 24. The transfer roller 26 transfers developed toner onto paper. The fuser unit 27 fuses the toner transferred to the papers by applying high heat and pressure. Also, the paper discharge rollers 28 enable the paper discharge unit 21 to discharge the fused papers. Below the printing unit 20, the paper storage cassette 30 and a pickup roller 33 are provided to store the papers and convey the papers separately.

In recent years, in order to minimize the digital multifunctional apparatus typically the height of the paper discharge unit 21 is reduced. For example, an outlet of the paper discharge unit 21 is usually designed to have a height of about 70 mm. Since the paper discharge unit 21 interposed between the scanning unit 10 and the printing unit 20 is designed to be a minimum size, as shown in FIG. 1, it is inconvenient to remove a discharged paper from the narrow outlet of the paper discharge unit 21. In particular, when a very small-sized paper, such as a postcard-size paper, is printed and discharged, since the paper is discharged and stored on an inner surface of the paper discharge unit 21, it is quite inconvenient to remove the paper.

Also, the paper discharge unit 21 becomes too small when a larger number of papers are discharged. Further, if a paper jam occurs between the small scanning unit 10 and the printing unit 20, it is troublesome for a user to remove the jammed paper. According to the circumstances, failures may be repeatedly caused during a print operation before the user can come to the apparatus to remove or check for a torn sheet. However, if the paper discharge unit 21 is formed with a sufficient height so as to increase the discharge space and facilitate removal of even a small paper, it would be impossible to manufacture a compact apparatus and inevitably the cost of materials and the weight of the apparatus would increase.

To overcome the foregoing problem, the scanning unit 10 may be rotatably designed using a hinge member. However, in this case, the scanning unit 10 cannot be easily attached to or detached from the printing unit 20, and the manufacturing process becomes complicated and the production cost increases due to the addition of the hinge member.

Accordingly, there is a need for a scanning unit that is combined with a printing unit in small unit while still being convenient to operate without greatly increasing manufacturing costs.

### SUMMARY OF THE INVENTION

The present invention provides a digital multifunctional apparatus, which is configured to rotate a scanning unit without using a complicated hinge member so that discharged papers can be easily taken out of the apparatus and a sufficient space for storing the discharged papers can be formed.

The present invention also provides a small-sized digital multifunctional apparatus in which a space between a scanning unit and a paper discharge unit is minimized.

The present invention further provides a digital multifunctional apparatus, which is configured to rotate a scanning unit so as to easily clear a paper jam that has occurred during a printing operation.

According to an aspect of the present invention, there is provided a digital multifunctional apparatus having a rotational scanning unit, in which the scanning unit scans a document and converts an optical signal into an electric signal, a printing unit, on which the scanning unit is mounted, prints an image to papers, and a paper discharge unit occupies a predetermined space adjacent to the scanning unit in an upper portion of the printing unit and stores the printed papers. The apparatus includes a combining unit, which combines the scanning unit with the printing unit so that the scanning unit is capable of being attached to and detached from the printing unit, and allows the scanning unit to rotate on the printing unit; and a fuser unit, which prevents fluctuation of the scanning unit over the printing unit.

The combining unit may comprise one or more scanning unit coupling members, each including a first member, which vertically extends from one terminal portion of a bottom surface of the scanning unit, and a second member, which extends from a terminal portion of the first member to be substantially parallel to the bottom surface of the scanning unit; and one or more scanning unit connecting grooves, each being formed in a portion of a top surface of the printing unit corresponding to one scanning unit coupling member and rotatably accommodating the scanning unit coupling member.

The combining unit may further comprise one or more connecting groove covers, each limiting rotation of the scanning unit within a predetermined range of angle and partially covering one scanning unit connecting groove so as to prevent fluctuation of the scanning unit.

The fuser unit may comprise at least one or more scanning unit fixing guides being protrusively formed on both sides of the bottom surface of the scanning unit; and at least one or more guide grooves being formed in a portion of the top surface of the printing unit corresponding to the scanning unit fixing guides and into which the scanning unit fixing guides are inserted.

### BRIEF DESCRIPTION OF THE DRAWINGS

The above object and advantages of the present invention will become more apparent by describing in detail exemplary embodiments thereof with reference to the attached drawings in which:

FIG. 1 illustrates a conventional digital multifunctional apparatus;

FIG. 2 is a cross-sectional view of a rotational structure of a scanning unit of a digital multifunctional apparatus according to an embodiment of the present invention;

FIG. 3 is a rear view of the rotational structure of the scanning unit shown in FIG. 2;

FIGS. 4A through 4C are exploded views illustrating coupling members and fixing guides shown in FIG. 2;

FIGS. 5A and 5B are exploded views of the top surface of a printing unit according to an embodiment of the present invention;

FIG. 6 is a top view of the rotational structure shown in FIG. 2; and

FIG. 7 is a cross-sectional view of the digital multifunctional apparatus according to an embodiment of the present invention, in which the scanning unit is rotated upward.

### DETAILED DESCRIPTION OF THE EXEMPLARY EMBODIMENTS

Hereinafter, the structure and operation of a digital multifunctional apparatus having a rotational scanning unit according to embodiments of the present invention will be described in detail with reference to the appended drawings.

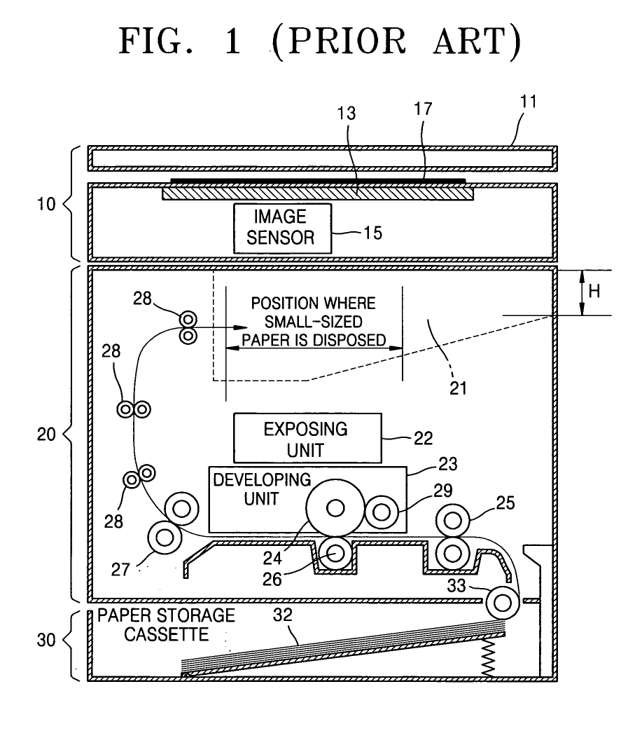

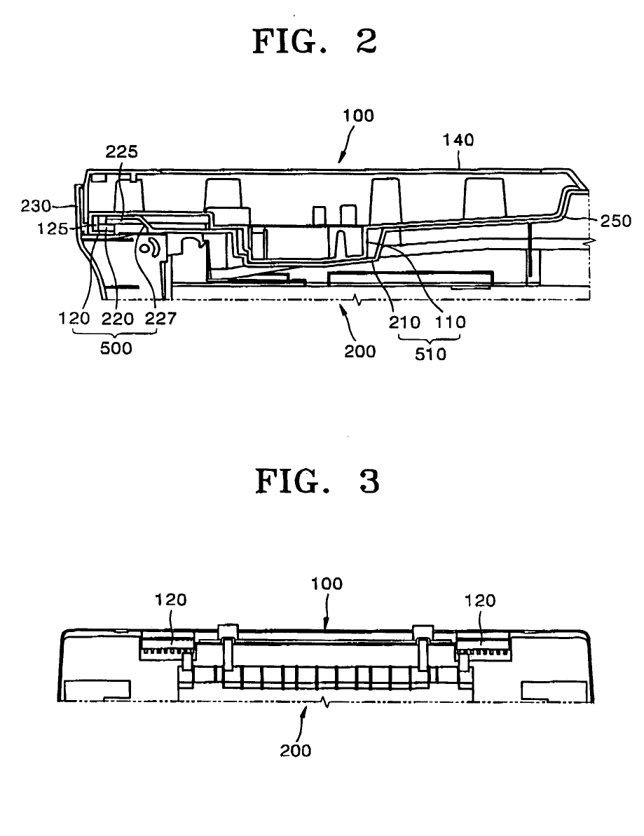

FIG. 2 is a cross-sectional view of a rotational structure of a scanning unit in a digital multifunctional apparatus according to an embodiment of the present invention. In FIG. 2, reference numeral 100 denotes the scanning unit of the digital multifunctional apparatus, and 200 denotes a printing unit on which the scanning unit 100 is mounted. Other components of the apparatus, which are not illustrated in the figure, are the same as in the conventional apparatus shown in FIG. 1. That is, the scanning unit 100 comprises a platen glass for mounting a document, a platen cover for covering a document or the platen glass, an image sensor for converting an optical signal obtained by scanning the document into an electric signal, and a scanning unit housing 140 for housing the scanning unit 100 to which these components are preferably fixed. In the meantime, within the printing unit 200 located under the scanning unit 100, a paper discharge unit, which stores papers that have been printed and discharged, occupies a predetermined space. Also, the printing unit 200 comprises an image forming unit having a developing unit and a photosensitive material, a transfer unit for transferring a developed toner to a paper, a fuser unit for fusing the transferred toner on the paper by applying high heat and pressure to the paper, at least one or more discharge rollers for discharging the paper to the paper discharge unit, and a printer unit housing 250 for housing the printing unit 200 to which these components are preferably fixed.

Referring to FIG. 2, the scanning unit 100 is rotatably combined with the printing unit 200 by a coupling member 120 for the scanning unit 100, which is installed on a bottom surface of the scanning unit housing 140. The scanning unit 100 and the printing unit 200 are combined to form the combining unit 500. The combining unit 500 is comprised of one or more scanning unit coupling members 120, one or more scanning unit connecting grooves 220 and one or more connecting groove covers 227. A fuser unit 510 comprises one or more of the scanning unit fixing guides 110 and one or more guide grooves 210 which correspond to the scanning unit fixing guides 110.

A connecting groove 220 for the scanning unit 100, which rotatably accommodates the coupling member 120, is formed in the printing unit housing 250. The connecting groove 220 is partially covered by a connecting groove cover 227. On the bottom surface of the scanning unit housing 140, a fixing guide 110 for the scanning unit 100 is protrusively formed to prevent excessive movement of the scanning unit 100 when the scanning unit 100 is combined with the printing unit 200. That is, when the scanning unit 100 is combined with the printing unit 200, the fixing guide 110 is inserted into a guide groove 210 that is formed in a top surface of the printing unit 200, so that the scanning unit 100 can be stably mounted on the printing unit 200. An excessive rotation prevention wall 230 is formed on a rear surface (refer to a left portion of the figure) of the printing unit housing 250. This excessive rotation prevention wall 230 limits rotation of the scanning unit 100 to within a predetermined angular range of rotation, thereby preventing the scanning unit 100 from being detached from the printing unit 200 during rotation.

Each of the components that comprise the combining unit 300 will now be described in further detail with reference to FIGS. 3 through 7.

FIG. 3 is a rear view of the rotational structure of the scanning unit 100 shown in FIG. 2. In FIG. 3, the excessive rotation prevention wall 230 is omitted to illustrate the rotational structure of the scanning unit 100.

Referring to FIG. 3, the scanning unit 100 is rotatably combined with the printing unit 200 by a pair of coupling members 120, which are symmetrically formed at the bottom surface of the scanning unit housing 140.

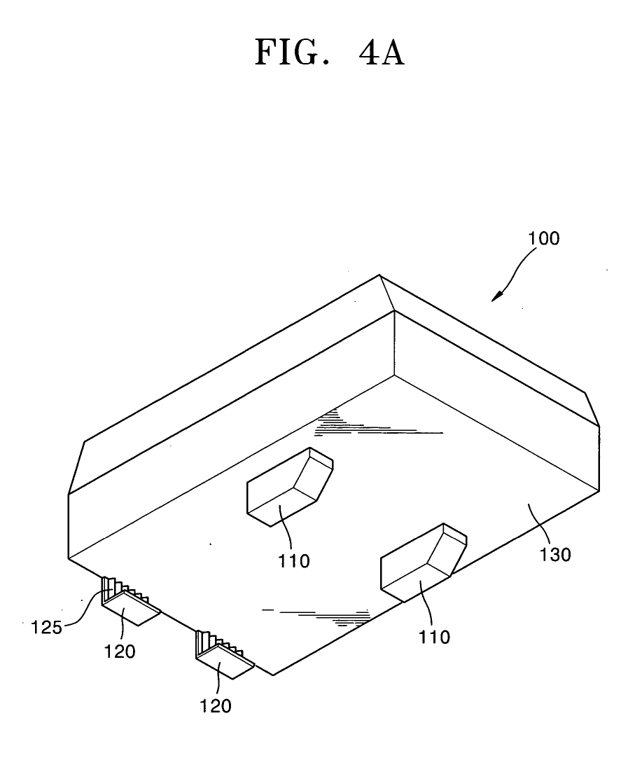

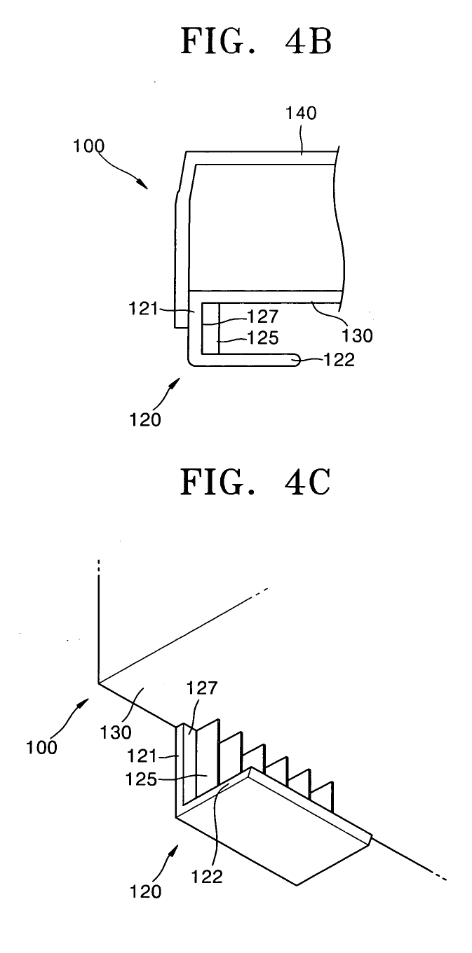

FIGS. 4A through 4C are exploded views illustrating the coupling members 120 and the fixing guides 110 shown in FIG. 2. FIG. 4A is a perspective view of an entire bottom 130 of the scanning unit housing 140, FIG. 4B is a cross-sectional view of the coupling member 120, and FIG. 4C is a perspective view of the coupling member 120.

Referring to FIG. 4A, the coupling members 120 are preferably integrally formed with one terminal portion of the bottom 130 of the scanning unit housing 140. Although two coupling members 120 are symmetrically illustrated in FIG. 4A, one or three or more coupling members 120 may be formed instead. Also, the fixing guides 110 are protrusively formed on the bottom 130 of the scanning unit housing 140. When the scanning unit 100 is combined with the printing unit 200, each of the fixing guides 110 is inserted into the guide groove 210 of the printing unit 200 to prevent excessive movement of the scanning unit 100 over the printing unit 200. It is illustrated in FIG. 4A that two fixing guides 110 are symmetrically formed on the bottom 130 of the scanning unit housing 140, but they may also be asymmetrically formed. Further, one or three or more fixing guides 110 may be formed.

The coupling member 120 is illustrated in detail in FIG. 4B. Referring to FIG. 4, the coupling member 120 has a bent bar shape. To be more specific, the coupling member 120 has a support 121, which vertically extends downward from a terminal portion of the bottom 130 of the scanning unit housing 140, and a lower surface 122, which extends from the support 121 and is bent toward the bottom 130 by about 90° in nearly parallel to the bottom 130. Also, on an inner wall 127 of the support 121, a plurality of ribs 125 are integrally formed from the bottom 130 of the scanning unit housing 140 to the lower surface 122 in a vertical direction. The ribs 125 function as a reinforcing member that prevents the coupling member 120 from bending. To facilitate a clearer understanding of the coupling member, another perspective view of the coupling member 120 is illustrated in FIG. 4C.

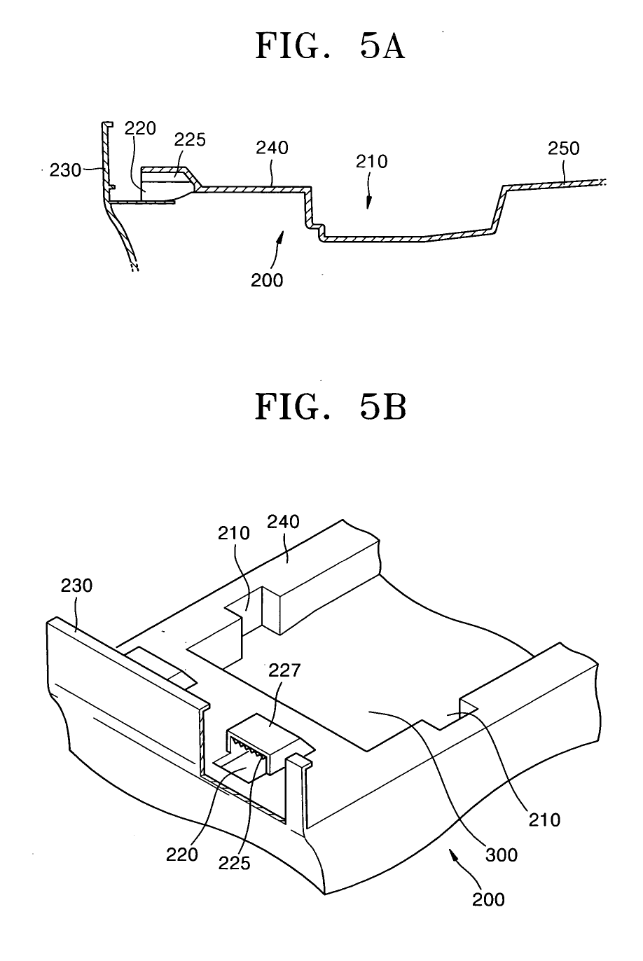

In the meantime, FIGS. 5A and 5B illustrate the printing unit 200 of the digital multifunctional apparatus according to an embodiment of the present invention, which comprises the connecting groove 220 and the guide groove 210, which correspond to the coupling member 120 and the fixing guide 110, respectively. FIG. 5A is a cross-sectional view of the printing unit 200, and FIG. 5B is a perspective view of the printing 200, which illustrates the connecting groove 220.

Referring to FIG. 5A, the connecting groove 220, which rotatably accomodates the coupling member 120, is formed in a portion of a top surface 240 of the printing unit housing 250, which corresponds to the coupling member 120 of the scanning unit 100. Also, the guide groove 210 is formed in a portion of the top surface 240 of the printing unit housing 250, which corresponds to the fixing guide 110 of the scanning unit 100. Like the coupling member 120, two connecting grooves 220 may be symmetrically formed, or one or three or more connecting grooves 220 may be formed. Also, like the fixing guide 110, two guiding grooves 210 may be symmetrically formed, or one or three or more connecting grooves 210 may be formed.

When the scanning unit 100 is combined with the printing unit 200, the connecting groove cover 227 partially covers the connecting groove 220. The connecting groove cover 227 serves to limit rotation of the scanning unit 100 within a predetermined angular range of rotation and prevent excessive movement of the scanning unit 100. An inlet of the connecting groove cover 227 faces outward so that the coupling member 120 can be properly accommodated in the connecting groove 220 and rotate. Also, a plurality of ribs 225 are formed inward from the inlet of the connecting groove cover 227 on a lower surface of the connecting groove cover 227. The ribs 225 function as a reinforcing member that prevents the connecting groove cover 227 from being bent.

Also, the excessive rotation prevention wall 230 is formed to vertically extend upward from one terminal portion of the top surface 240 of the printing unit housing 250. The excessive rotation prevent wall 230 prevents the scanning unit 100 from rotating by more than a predetermined angle. As shown in FIG. 5B, the excessive rotation prevent wall 230 is installed to face the inlet of the connecting groove cover 227. A terminal portion of the excessive rotation prevention wall 230 is preferably bent by about 90° toward the top surface 240 of the printing unit housing 250 to be nearly parallel to the top surface 240. As shown in FIG. 7, which will be described later, when a user lifts up a front surface of the scanning unit 100 and thus the scanning unit 100 rotates about the coupling member 120, a rear surface of the scanning unit 100 comes into contact with a corner of a bent terminal portion of the excessive rotation prevent wall 230. Thus, detaching the scanning unit 100 from the printing unit 200 can be prevented during rotation. To prevent excessive rotation of the scanning unit 100, the height of the excessive rotation prevention wall 230 is not greater than that of the scanning unit 100.

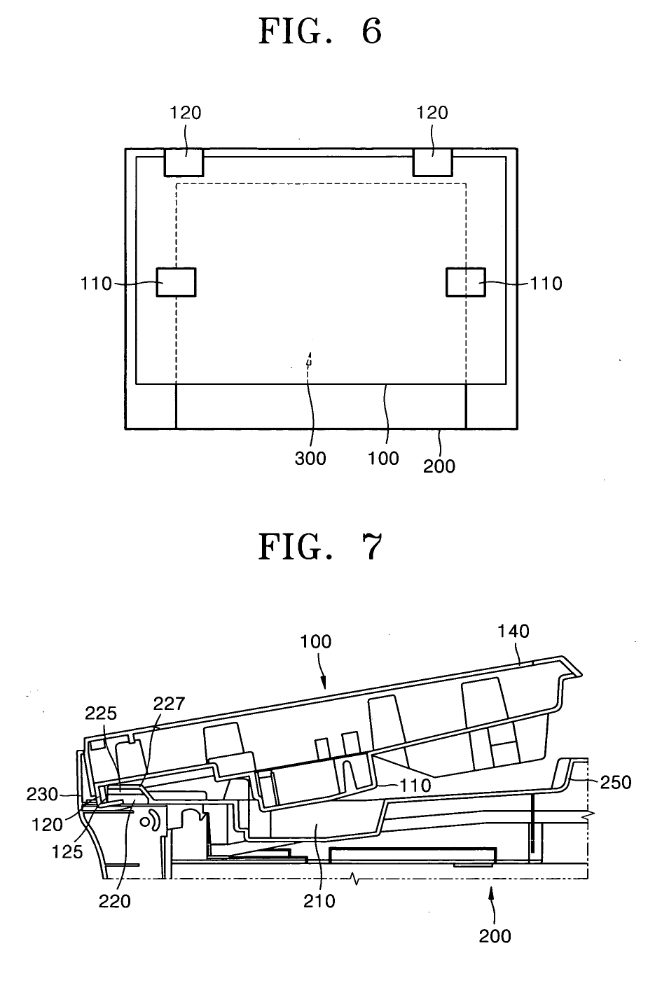

FIG. 6 is a top view of the rotational structure shown in FIG. 2.

Referring to FIGS. 5B and 6, a paper discharge unit 300 for storing papers is concavely formed in the top surface 240 of the printing unit housing 250. The paper discharge unit 300 occupies a predetermined space ranging from the front surface of the printing unit 200 to nearby the rear surface thereof. The coupling member 120 is combined with the connecting groove 110 formed in the rear surface of the printing unit 200. Also, the guide grooves 210, which correspond to the fixed guides 110, are formed on both sides of the paper discharge unit 300. When the scanning unit 100 is combined with the printing unit 200, the fixing guides 110 are inserted into the guide grooves 210, thereby preventing excessive motion of the scanning unit 100 over the printing unit 200.

Hereinafter, the operation of the digital multifunctional apparatus will be described in detail with reference to FIG. 7. FIG. 7 is a cross-sectional view of a digital multifunctional apparatus having a rotational scanning unit according to an embodiment of the present invention, in which the scanning unit 100 is rotated upward.

At the outset, to combine the scanning unit 100, which is capable of being attached and detached with the printing unit 200, the scanning unit 100 is tilted and the coupling member 120 is inserted into the connecting groove 220 of the printing unit 200. Next, the scanning unit 100 is put down such that the fixing guides 110 are inserted into the guide grooves 210. FIG. 2 illustrates the scanning unit 100 combined with the printing unit 200.

As the digital multifunctional apparatus performs a print operation, a printed paper is stored in the paper discharge unit 300. Although papers having a typical size, such as A4 papers, are easily removed from the paper discharge unit 300, small-sized papers, for example, postcard-size papers, cannot be easily removed through the small inlet of the paper discharge unit 300. In this case, a user can lift up a front surface portion of the scanning unit 100 such that the scanning unit 100 rotates about the coupling member 120 as shown in FIG. 7. Then, the paper discharge unit 300 formed on the top surface 240 of the printing unit housing 250 is exposed, and thus the user can easily remove even a small paper. If the scanning unit 100 rotates by more than a predetermined angle, the coupling member 120 and a rear surface of the scanning unit 100 come into contact with the connecting groove cover 227 and the excessive rotation prevention wall 230, respectively, thereby preventing excessive rotation of the scanning unit 100. As a result, detaching the scanning unit 100 from the printing unit 200 is prevented during rotation. After the discharged paper or the paper jam is cleared by lifting up the scanning unit 100, the user may let go of the scanning unit 100 and thus the scanning unit 100 is naturally dropped and returned to where the scanning unit 100 was.

As explained thus far, since the scanning unit 100 can rotate on the printing unit 200, even though a space for paper discharge is small, a discharged paper or a paper jam can be easily cleared. Therefore, a digital multifunctional apparatus can be manufactured with a small size by designing the discharge space to have a minimum size. In addition, the scanning unit can be rotated without a complicated hinge member. Consequently, the apparatus, in which the scanning unit 100 is easily attached to or detached from the printing unit 200, can be economically manufactured in a short amount of time.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A digital multifunctional apparatus having a rotatable scanning unit, in which the scanning unit scans a document and converts an optical signal into an electrical signal, a printing unit, on which the scanning unit is mounted, prints an image on paper, and a paper discharge unit occupies a predetermined space adjacent to the scanning unit in an upper portion of the printing unit and stores the printed paper, the apparatus comprising:
a combining unit for combining the scanning unit with the printing unit capable of being attached to and detached from the printing unit and allowing the scanning unit to rotate on the printing unit; and
a fuser unit for preventing fluctuation of the scanning unit over the printing unit.

2. The apparatus of claim 1, wherein the combining unit comprises:
one or more scanning unit coupling members, each including a first member, which vertically extends from one terminal portion of a bottom surface of the scanning unit, and a second member, which extends from a terminal portion of the first member to be substantially parallel to the bottom surface of the scanning unit; and
one or more scanning unit connecting grooves, each being formed in a portion of a top surface of the printing unit corresponding to one scanning unit coupling member and rotatably accommodating the scanning unit coupling member.

3. The apparatus of claim 2, wherein each of the scanning unit coupling members includes a plurality of ribs being vertically formed between the bottom surface of the scanning unit and the second member.

4. The apparatus of claim 2, wherein the combining unit further comprises one or more connecting groove covers, each limiting rotation of the scanning unit within a predetermined range of angle and partially covering one scanning unit connecting groove so as to prevent fluctuation of the scanning unit.

5. The apparatus of claim 4, wherein each of the connecting groove covers partially protrudes from the top surface of the printing unit.

6. The apparatus of claim 4, wherein each of the connecting groove covers includes a plurality of ribs being formed inward from an inlet of the scanning unit connecting groove.

7. The apparatus of claim 1, wherein the fuser unit comprises:
at least one or more scanning unit fixing guides being protrusively formed on both sides of the bottom surface of the scanning unit; and
at least one or more guide grooves being formed in a portion of the top surface of the printing unit corresponding to the scanning unit fixing guides and into which the scanning unit fixing guides are inserted.

8. The apparatus of claim 7, wherein the scanning unit fixing guides and the scanning unit guide grooves are symmetrically formed on both sides of the paper discharge unit on the basis of a direction in which a paper is discharged.

9. The apparatus of claim 2, further comprising an excessive rotation prevention wall extending vertically from one terminal portion of the top surface of the printing unit adjacent to the scanning unit connecting groove.

10. The apparatus of claim 9, wherein the height of the excessive rotation prevention wall is not greater than the height of the scanning unit.

11. The apparatus of claim 9, wherein a terminal portion of the excessive rotation prevention wall is partially bent toward the scanning unit.

12. The apparatus of claim 2, wherein two scanning coupling members are symmetrically formed on the bottom surface of the scanning unit, and two scanning unit connecting grooves, which correspond to the two scanning coupling members, respectively, are symmetrically formed on the top surface of the printing unit.
